(19) United States
(12) Patent Application Publication
(10) Pub. No.: US 2007/0263090 A1
(43) Pub. Date: Nov. 15, 2007

(54) Method and Apparatus for Automatic Exposure of an In-Vehicle Camera

(76) Inventor: Koichi Abe, Iwaki-city (JP)

Correspondence Address: BRINKS HOFER GILSON & LIONE, P.O. BOX 10395, CHICAGO, IL, 60610, US

(21) Appl. No.: 11/695,852

(22) Filed: Apr. 3, 2007

(30) Foreign Application Priority Data
May 12, 2006 (JP) 2006-133747

(51) Int. Cl. H04N 7/18; G08G 1/14

(52) U.S. Cl. 348/148; 340/932.2

(57) ABSTRACT

In an automatic exposure method/apparatus, a metering area setting apparatus sets a metering area for use in automatic exposure of an in-vehicle camera installed in a vehicle such that, when the in-vehicle camera takes an image of a vehicle and a surrounding scene including at least a ground surface of a parking space or other areas surrounding a vehicle such as a road surface in a nearby area around the vehicle, an exposure condition becomes optimum for a particular area of interest in the total imaging area of the in-vehicle camera.

### RELATED APPLICATIONS

The present application claims priority to Japanese Patent Application Serial Number 2006-133747, filed May 12, 2006, the entirety of which is hereby incorporated by reference.

### BACKGROUND OF THE INVENTION

1. Field of the Invention

The present invention relates to a method and apparatus for automatic exposure of an in-vehicle camera, and more particularly, to a method and apparatus for automatic exposure of an in-vehicle camera installed in a vehicle.

2. Description of the Related Art

In recent years, driving assist systems have been proposed which are capable of taking using an in-vehicle camera to take an image of a vehicle and its surroundings viewed from above the vehicle, at a parking lot or the like, and displaying the image on a display of an in-vehicle apparatus such as an in-vehicle navigation apparatus (for example, see Japanese Unexamined Patent Application Publication No. 2005-324593).

In such a system, a plurality of wide angle cameras each having a wide angle lens, such as a fisheye lens, are installed at different positions (for example, at a front position, a rear position, a left-hand side position, and a right-hand side position) of a vehicle.

An image of the vehicle and its surroundings viewed from above is then produced using images, taken by the respective wide angle cameras, of a scene including a ground surface of a parking space, or other areas such as road surfaces that are near the vehicle.

It has also been proposed to extract, from an image taken by a wide angle camera used as an in-vehicle camera, a particular area of interest including a road surface in a nearby area around a vehicle and produce an enlarged image from the extracted image. The enlarged image is displayed on a display to allow a driver to identify obstacles near a vehicle to prevent an accident from occurring.

As described above, various techniques using an in-vehicle camera have been proposed (for example, see Japanese Unexamined Patent Application Publication No. 2005-324593 and Japanese Unexamined Patent Application Publication No. 2005-135203).

In the known techniques, when automatic exposure of an in-vehicle camera is performed, metering is performed generally by using the whole imaging area of the in-vehicle camera as the metering area while greatly weighting a central part of the imaging area (more particularly, a central part of a photo sensing surface of a CCD). The above-described metering method is known as center-weighted metering.

However, when an exposure condition is determined based on the center-weighted metering, the determined exposure condition is not always optimal. For example, to produce an image of a vehicle and a surrounding scene viewed from above at an outdoor parking lot or the like, the image of the surrounding scene including a ground surface of the parking lot is taken by a wide angle in-vehicle camera. However, as shown in FIG. 13, the imaging area 1 of the wide angle camera includes not only the ground surface 2 of the parking lot but can also include an unnecessary object such as the sky or a part of the vehicle.

In the conventional technique, to reduce the above problem, metering is performed over the entire imaging area 1 while greatly weighting the center part 3 (enclosed by the dashed line in FIG. 13), the exposure condition is automatically determined according to the metering result, and the image of the surrounding scene in the imaging area 1 is taken under the determined exposure condition.

A particular area is then extracted from the taken image of the surrounding scene to obtain an image including only the ground surface 2 of the parking lot. More specifically, for example, an image of a surrounding scene viewed from above the vehicle is produced using an image of the ground surface 2 of the parking lot captured in a partial area 4 (enclosed by a broken line in FIG. 13) in the imaging area 1. The unnecessary part of the image such as the sky or the part of the vehicle in the imaging area is discarded.

However, in this technique in which the entire imaging area 1 is used as the metering area 5, even when the ground surface 2 of the parking lot is located in the central part 3 of the imaging area 1 and thus the metering is performed such that a high weighting factor is given to the ground surface 2, the exposure condition is still influenced by the brightness of the unnecessary part such as the sky.

More specifically, for example, when the brightness of the sky is very high compared with the brightness of the ground surface 2 of the parking lot in FIG. 13, it is determined in the metering process that the surrounding scene captured in the imaging area 1 has a high average value of brightness (higher than the brightness of the ground surface 2 of the parking lot), and the exposure condition is determined based on the assumption that the brightness is high. As a result, the brightness of the ground surface in the taken image becomes too low (that is, the image is taken under an underexposure condition).

FIG. 14 shows an example in which an image of a ground surface 2 of a parking lot is taken in the nighttime using a wide angle lens. In this example, the imaging area 1 includes an image of the sky with very low brightness compared with the brightness of the ground surface 2 of the parking lot. In this case, the metering of the imaging area 1 is influenced by the very dark image of the sky although the metering is performed such that a high weighting factor is given to the central part 3 of the imaging area 1, and thus it is determined in the metering process that the average brightness of the scene in the imaging area 1 is low (that is, the evaluated average brightness is lower than the actual brightness of the ground surface 2 of the parking lot).

In the example shown in FIG. 14, the image of the ground surface 2 of the parking lot in the imaging area 1 includes areas 2a with high brightness illuminated with light emitted from headlamps of a vehicle. These areas 2a are out of the central area 3, and thus the large weighting factor is not given to these areas 2a in the metering.

Thus, in the example shown in FIG. 14, the image is taken under an exposure condition that causes the brightness of the areas 2a illuminated by the light emitted from the headlamps to become too high (that is, the image is taken under an overexposure condition).

In a parking lot located close to a building, light reflected from the building can have a similar adverse influence on the exposure to the influence of the sky.

In a case where an in-vehicle camera receives direct sunlight, the direct sunlight causes the scene captured in the imaging area 1 to be evaluated as having high average brightness (that is, the brightness is evaluated as higher than the actual brightness of the ground surface 2 of the parking lot), and the too high value of the evaluated brightness causes the exposure condition to be determined such that the image of the ground surface of the parking lot becomes too dark (that is, the image is taken under an underexposure condition).

In the conventional technique, as described above, the brightness of an object located in an area out of the ground surface 2 of the parking lot has an adverse influence on the determination of the exposure condition. This makes it difficult to produce a good image of the vehicle and the surrounding scene viewed from above. FIG. 15 shows an example of a bad image in which there is a great difference in brightness between an area in front of the vehicle and an area behind the vehicle or between an area to the left and an area to the right of the vehicle.

In the conventional technique, because metering is performed using the entire imaging area of the in-vehicle camera as the metering area, when a particular area is extracted for a particular use from the total area of the image, the extracted image does not always have proper brightness depending on the situation.

### SUMMARY OF THE INVENTION

In view of the above-described problems, it is an object of the present invention to provide a method and apparatus for automatic exposure of an in-vehicle camera, capable of obtaining proper brightness for a particular area of interest in the imaging area of the in-vehicle camera.

To achieve the above object, the present invention provides an in-vehicle camera automatic-exposure apparatus comprising a metering area setting apparatus configured to set a metering area for use in automatic exposure in taking an image, by an in-vehicle camera installed in a vehicle, of a surrounding scene including at least one of a ground surface of a parking space, an area surrounding a vehicle, and a road surface in a nearby area around the vehicle such that an exposure condition determined based on the metering area becomes optimal for a particular area of interest of the image taken by the in-vehicle camera, the automatic exposure being performed using the metering area set by the metering area setting apparatus. In this configuration, when the exposure condition is determined based on the metering area set by the metering area setting apparatus, the resultant exposure condition becomes optimal for the particular area of interest of the image taken by the in-vehicle camera.

In the in-vehicle automatic-exposure apparatus according to the present invention, the image in the particular area of interest may be an image to be used to produce an image of the vehicle and surroundings thereof viewed from above the vehicle, and the metering area setting apparatus may be configured to set the metering area depending on the location where the in-vehicle camera is installed. In this configuration, when the exposure condition is determined based on the metering area set by the metering area setting apparatus, the resultant exposure condition becomes optimal, depending on the installation location of the in-vehicle camera, for the particular area of interest of the image used to produce the image of the vehicle and surroundings thereof viewed from above the vehicle.

In the in-vehicle automatic-exposure apparatus according to the present invention, the image in the particular area of interest may be an image to be used to produce an image of the vehicle and surroundings thereof viewed from above the vehicle, and the metering area setting apparatus may be configured to set the metering area depending on time. In this configuration, when the exposure condition is determined based on the metering area set by the metering area setting apparatus, the resultant exposure condition becomes optimal, depending on the time, for the particular area of interest of the image used to produce the image of the vehicle and surroundings thereof viewed from above the vehicle.

In the in-vehicle automatic-exposure apparatus according to the present invention, the image in the particular area of interest may be an image to be used to produce an image of the vehicle and surroundings thereof viewed from above the vehicle, and the metering area setting apparatus may be configured to set the metering area depending on the direction of the vehicle. In this configuration, when the exposure condition is determined based on the metering area set by the metering area setting apparatus, the resultant exposure condition becomes optimal, depending on the direction of the vehicle, for the particular area of interest of the image used to produce the image of the vehicle and surroundings thereof viewed from above the vehicle.

In the in-vehicle automatic-exposure apparatus according to the present invention, the image in the particular area of interest may be an image to be used to produce an image of the vehicle and surroundings thereof viewed from above the vehicle, and the metering area setting apparatus may be configured to set the metering area depending on at least one of the location where the in-vehicle camera is installed, time, and the direction of the vehicle. In this configuration, when the exposure condition is determined based on the metering area set by the metering area setting apparatus, the resultant exposure condition becomes optimal, depending on at least the installation location of the in-vehicle camera, the time, or the direction of the vehicle, for the particular area of interest of the image used to produce the image of the vehicle and surroundings thereof viewed from above the vehicle.

In the in-vehicle automatic-exposure apparatus according to the present invention, the image in the particular area of interest may be an image to be used to produce an image of the vehicle and surroundings thereof viewed from above the vehicle, and the metering area setting apparatus may be configured to set the metering area so as to include an area equal or approximately equal to the particular area of interest of the image to be used. In this configuration, the metering area setting apparatus is capable of setting the metering area so as to include an area equal or approximately equal to the particular area of interest of the image to be used to produce the image of the vehicle and surroundings thereof viewed from above the vehicle.

In the in-vehicle automatic-exposure apparatus according to the present invention, the image of the particular area of interest may be an image to be extracted, for use, from the image of the surrounding scene taken by the in-vehicle camera, and the metering area setting apparatus may be configured to set the metering area so as to include an area equal or approximately equal to the particular area of interest of the image to be used. In this configuration, the metering area setting apparatus is capable of setting the metering area so as to include an area equal or approximately equal to the particular area of interest of the image to be extracted, for use, from the image of the surrounding scene taken by the in-vehicle camera.

In the in-vehicle automatic-exposure apparatus according to the present invention, the image in the particular area of interest may be an image which is extracted from the image of the surrounding scene taken by the in-vehicle camera and which is used to produce an image for checking that there is no obstacle. In this configuration, the metering area setting apparatus is capable of setting the metering area so as to include an area equal or approximately equal to the particular area of interest of the image which is extracted from the image of the surrounding scene taken by the in-vehicle camera and which is used to produce an image for checking whether there is an obstacle.

In the in-vehicle automatic-exposure apparatus according to the present invention, the in-vehicle camera may be a wide angle camera. In this configuration, when the exposure condition is determined based on the metering area set by the metering area setting apparatus, the resultant exposure condition becomes optimal for the particular area of interest of the image taken by the wide angle camera used as the in-vehicle camera.

The present invention also provides an in-vehicle automatic-exposure method, comprising the steps of setting a metering area for use in automatic exposure in taking an image, by an in-vehicle camera installed in a vehicle, of a surrounding scene including at least a ground surface of a parking space or other place or a road surface in a nearby area around the vehicle such that an exposure condition determined based on the metering area becomes optimal for a particular area of interest of the image taken by the in-vehicle camera, and performing the automatic exposure using the metering area set in the setting step. This method makes it possible to set the metering area such that an exposure condition determined based on the metering area is optimal for the particular area of interest of the image taken by the in-vehicle camera.

In the in-vehicle automatic-exposure method according to the present invention, the image in the particular area of interest may be an image to be used to produce an image of the vehicle and surroundings thereof viewed from above the vehicle, and, in the metering area setting step, the metering area may be set depending on the location where the in-vehicle camera is installed. This method makes it possible to set the metering area such that an exposure condition determined based on the metering area becomes optimal, depending on the installation location of the in-vehicle camera, for the particular area of interest of the image used to produce the image of the vehicle and surroundings thereof viewed from above the vehicle.

In the in-vehicle automatic-exposure method according to the present invention, the image in the particular area of interest may be an image to be used to produce an image of the vehicle and surroundings thereof viewed from above the vehicle, and, in the metering area setting step, the metering area may be set depending on time. This method makes it possible to set the metering area such that an exposure condition determined based on the metering area becomes optimal, depending on the time, for the particular area of interest of the image used to produce the image of the vehicle and surroundings thereof viewed from above the vehicle.

In the in-vehicle automatic-exposure method according to the present invention, the image in the particular area of interest may be an image to be used to produce an image of the vehicle and surroundings thereof viewed from above the vehicle, and, in the metering area setting step, the metering area may be set depending on the direction of the vehicle. This method makes it possible to set the metering area such that an exposure condition determined based on the metering area becomes optimal, depending on the vehicle direction, for the particular area of interest of the image used to produce the image of the vehicle and surroundings thereof viewed from above the vehicle.

In the in-vehicle automatic-exposure method according to the present invention, the image in the particular area of interest may be an image to be used to produce an image of the vehicle and surroundings thereof viewed from above the vehicle, and, in the metering area setting step, the metering area may be set depending on at least one of the location where the in-vehicle camera is installed, the time, and the direction of the vehicle. This method makes it possible to set the metering area such that an exposure condition determined based on the metering area becomes optimal, depending on at least the installation location of the in-vehicle camera, the time, or the direction of the vehicle, for the particular area of interest of the image used to produce the image of the vehicle and surroundings thereof viewed from above the vehicle.

In the in-vehicle automatic-exposure method according to the present invention, the image in the particular area of interest may be an image to be used to produce an image of the vehicle and surroundings thereof viewed from above the vehicle, and, in the metering area setting step, the metering area may be set so as to include an area equal or approximately equal to the particular area of interest of the image to be used. This method makes it possible to set the metering area so as to include an area equal or approximately equal to the particular area of interest of the image to be used to produce the image of the vehicle and surroundings thereof viewed from above the vehicle.

In the in-vehicle automatic-exposure method according to the present invention, the image of the particular area of interest may be an image to be extracted, for use, from the image of the surrounding scene taken by the in-vehicle camera, and, in the metering area setting step, the metering area may be set so as to include an area equal or approximately equal to the particular area of interest of the image to be used. This method makes it possible to set the metering area so as to include an area equal or approximately equal to the particular area of interest of the image to be extracted, for use, from the image of the surrounding scene taken by the in-vehicle camera.

In the in-vehicle automatic-exposure method according to the present invention, the image in the particular area of interest may be an image which is extracted from the image of the surrounding scene taken by the in-vehicle camera and which is used to produce an image for checking that there is no obstacle. This method makes it possible to set the metering area so as to include an area equal or approximately equal to the particular area of interest of the image which is extracted from the image of the surrounding scene taken by the in-vehicle camera and which is used to produce an image for checking whether there is an obstacle.

In the in-vehicle automatic-exposure method according to the present invention, a wide angle camera may be used as the in-vehicle camera. This method makes it possible to set the metering area such that an exposure condition determined based on the metering area becomes optimal for the particular area of interest of the image taken by the wide angle camera used as the in-vehicle camera.

The present invention provides great advantages. That is, in an aspect of the present invention, the metering area can be set such that an exposure condition determined based on the metering area is optimal for the particular area of interest of the image taken by the in-vehicle camera, and thus the image in the area of interest taken by the in-vehicle camera can have optimal brightness.

In an aspect of the present invention, the metering area can be set such that an exposure condition determined based on the metering area becomes optimal, depending on the installation location of the in-vehicle camera, for the particular area of interest of the image used to produce the image of the vehicle and surroundings thereof viewed from above the vehicle, and thus the image in the particular area of interest, used to produce the image of the vehicle and surroundings thereof viewed from above the vehicle, can have optimal brightness regardless of the installation location of the in-vehicle camera.

In an aspect of the present invention, the metering area can be set such that an exposure condition determined based on the metering area becomes optimal, depending on the time, for the particular area of interest of the image used to produce the image of the vehicle and surroundings thereof viewed from above the vehicle, and thus the image in the particular area of interest, used to produce the image of the vehicle and surroundings thereof viewed from above the vehicle, can have optimal brightness regardless of the time.

In an aspect of the present invention, the metering area can be such that an exposure condition determined based on the metering area becomes optimal, depending on the vehicle direction, for the particular area of interest of the image used to produce the image of the vehicle and surroundings thereof viewed from above the vehicle, and more particularly such that the image in the particular area of interest, used to produce the image of the vehicle and surroundings thereof viewed from above the vehicle, has optimal brightness regardless of the direction of the vehicle.

In an aspect of the present invention, the metering area can be set such that an exposure condition determined based on the metering area becomes optimal, depending on at least the installation location of the in-vehicle camera, the time, or the direction of the vehicle, for the particular area of interest of the image used to produce the image of the vehicle and surroundings thereof viewed from above the vehicle, and thus the image in the particular area of interest, used to produce the image of the vehicle and surroundings thereof viewed from above the vehicle, can have optimal brightness regardless of the installation location of the in-vehicle camera, the time, and the direction of the vehicle.

In an aspect of the present invention, the metering area can be set so as to include an area equal or approximately equal to the particular area of interest of the image to be used to produce the image of the vehicle and surroundings thereof viewed from above the vehicle, and thus the image in the particular area of interest, used to produce the image of the vehicle and surroundings thereof viewed from above the vehicle, can have optimal brightness regardless of the time.

In an aspect of the present invention, the metering area can be set so as to include an area equal or approximately equal to the particular area of interest of the image to be extracted, for use, from the image of the surrounding scene taken by the in-vehicle camera, and thus the image in the particular area of interest to be extracted, for use, from the image of the surrounding scene taken by the in-vehicle camera can have optimal brightness.

In an aspect of the present invention, the metering area can be set so as to include an area equal or approximately equal to the particular area of interest of the image which is extracted from the image of the surrounding scene taken by the in-vehicle camera and which is used to produce an image for checking whether there is an obstacle, and thus the image in the particular area of interest, which is extracted from the image taken by the in-vehicle camera and which is used to produce an image for checking whether there is an obstacle, can have optimum brightness.

In an aspect of the present invention, the metering area can be set such that an exposure condition determined based on the metering area becomes optimal for the particular area of interest of the image taken by the wide angle camera used as the in-vehicle camera, and thus the image in the particular area of interest taken by the wide angle camera used as the in-vehicle camera can have optimum brightness.

### BRIEF DESCRIPTION OF THE DRAWINGS

FIG. 1 is a diagram showing one embodiment of an in-vehicle camera system including an automatic exposure apparatus;

FIG. 2 is a block diagram showing the details of an ECU in the in-vehicle camera system shown in FIG. 1;

FIG. 3 is a diagram showing an example of a manner in which the metering area of a rear camera is set when an image is taken by the rear camera in a parking lot in the daytime using an in-vehicle camera automatic-exposure method/apparatus;

FIG. 4 is a diagram showing an example of a manner in which the metering area of a front camera is set when an image is taken by the front camera in a parking lot in the daytime using an in-vehicle camera automatic-exposure method/apparatus;

FIG. 5 is a diagram showing an example of a manner in which the metering area of a front camera is set when an image is taken by the front camera in a parking lot in the nighttime using an in-vehicle camera automatic-exposure method/apparatus;

FIG. 6 is a diagram showing an example of a manner in which the metering area of a front camera is set when an image is taken by the front camera in a parking lot in the morning or evening using an in-vehicle camera automatic-exposure method/apparatus;

FIG. 7 is a diagram showing a state in which a vehicle is in a direction that causes a right-side camera to receive direct sunlight while a left-side camera does not receive direct sunlight;

FIG. 8 is a diagram showing an example of a manner in which metering areas of the right-size camera and the left-side camera are set when the vehicle is in the direction shown in FIG. 7, using an in-vehicle camera automatic-exposure method/apparatus;

FIG. 9 is a block diagram showing the details of an in-vehicle camera configured to operate with an in-vehicle camera automatic-exposure apparatus;

FIG. 10 is a diagram showing an example of an image of a vehicle and nearby surroundings thereof viewed from above the vehicle, taken using an in-vehicle camera automatic-exposure method;

FIG. 11 is a diagram schematically showing a step of producing an image for identifying obstacles near a vehicle, using an in-vehicle camera automatic-exposure method/apparatus;

FIG. 12 is a diagram showing an example of a manner in which, when a vehicle is going to turn to the right, a metering area is set for a right-side camera using an in-vehicle camera automatic-exposure method/apparatus;

FIG. 13 is a diagram showing one example of a manner in which at a parking lot in the daytime, a metering area for an in-vehicle camera is determined according to a conventional center-weighted metering technique;

FIG. 14 is a diagram showing one example of a manner in which at a parking lot in the nighttime, a metering area for an in-vehicle camera is determined according to a conventional center-weighted metering technique; and

FIG. 15 is a diagram showing one example of an image of a vehicle and a surrounding scene viewed from above according to a conventional technique.

### DESCRIPTION OF THE PREFERRED EMBODIMENTS

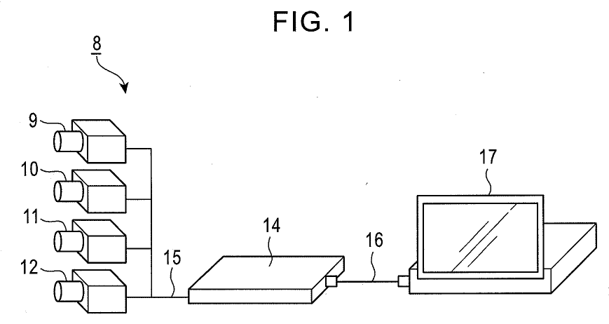

An in-vehicle camera automatic-exposure apparatus and an in-vehicle automatic-exposure method according to a first embodiment of the present invention are described below with reference to FIGS. 1 to 10.

FIG. 1 shows an in-vehicle camera system 8 including an in-vehicle camera automatic-exposure apparatus. This in-vehicle camera system 8 may include four in-vehicle cameras 9, 10, 11, and 12, which are part of the in-vehicle camera automatic-exposure apparatus. Each of these in-vehicle cameras 9, 10, 11, and 12 may be a wide angle camera having a wide angle lens such as a fisheye lens.

Of these in-vehicle cameras 9, 10, 11, and 12, the in-vehicle camera 9 is installed in a front part (for example, an emblem part) of the vehicle and is adapted to take an image of a scene in front of the vehicle. Hereinafter, the in-vehicle camera 9 will also be referred to as the front camera 9. The in-vehicle camera 10 is installed in a rear part (for example, a rear license garnish) of the vehicle and is adapted to take an image of a scene behind the vehicle. Hereinafter, the in-vehicle camera 10 will also be referred to as the back camera 10. The in-vehicle camera 11 is installed on a right side (for example, on a right-side door mirror) of the vehicle and is adapted to take an image of a scene to the right of the vehicle. Hereinafter, this in-vehicle camera 11 will also be referred to as the right side camera 11. The in-vehicle camera 12 is installed on a left side (for example, on a left-side door mirror) of the vehicle and is adapted to take an image of a scene to the left of the vehicle. Hereinafter, this in-vehicle camera 12 will also be referred to as the left side camera 12.

The in-vehicle cameras 9, 10, 11, and 12 are connected, via communication connection means 15 such as a cable, to an ECU (Electronic Control Unit) 14 which form the in-vehicle camera automatic-exposure apparatus together with the in-vehicle cameras 9, 10, 11, and 12. The ECU 14 may also be connected to a display 17 via communication connection means 16 such as a cable.

The ECU 14 receives data of the image of the scene in front of the vehicle from the front camera 9, data of the image of the scene behind the vehicle from the back camera 10, data of the image of the scene to the right of the vehicle from the right side camera 11, and data of the image of the scene to the left of the vehicle from the left side camera 12. The ECU 14 produces an image showing the vehicle and its nearby surroundings viewed from above the vehicle, from the image data supplied from the in-vehicle cameras 9, 10, 11, and 12. The ECU 14 displays the resultant produced image on the display 17.

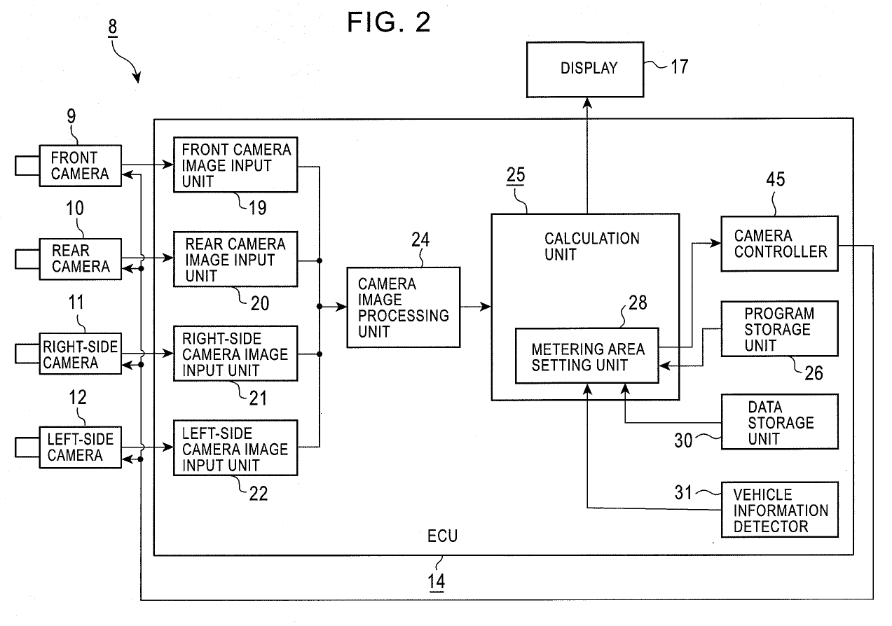

The ECU 14 is described in further detail below with reference to FIG. 2. The ECU 14 may include a front camera image input unit 19 whose input end is connected to the front camera 9. Analog image data output from the front camera 9 is input to the front camera image input unit 19. The front camera image input unit 19 converts the input image data supplied from the front camera 9 from analog form into digital form, and supplies the resultant digital image data to a part in the ECU 14.

The ECU 14 may also include a back camera image input unit 20 whose input end is connected to the back camera 10. Analog image data output from the back camera 10 is input to the back camera image input unit 20. The back camera image input unit 20 converts the image data input from the back camera 10 from analog form into digital form, and supplies the resultant digital image data to a part in the ECU 14.

The ECU 14 may also include a right side camera image input unit 21 whose input end is connected to the right side camera 11. Analog image data output from the right side camera 11 is input to the right side camera image input unit 21. The right side camera image input unit 21 converts the input image data supplied from the right side camera 11 from analog form into digital form, and supplies the resultant digital image data to a part in the ECU 14.

The ECU 14 may also include a left side camera image input unit 22 whose input end is connected to the left side camera 12. Analog image data output from the left side camera 12 is input to the left side camera image input unit 22. The left side camera image input unit 22 converts the image data input from the left side camera 12 from analog form into digital form, and supplies the resultant digital image data to a part in the ECU 14.

The output end of each of the front camera image input unit 19, the back camera image input unit 20, the right side camera image input unit 21, and the left side camera image input unit 22 is connected to a camera image processing unit 24. Thus, the image data output from the respective in-vehicle cameras 9, 10, 11, and 12 are supplied to the camera image processing unit 24 via the camera image input units 19, 20, 21, and 22.

From the image data supplied from each of the in-vehicle cameras 9, 10, 11, and 12, the camera image processing unit 24 extracts a particular area of interest to be used to produce an image of the vehicle and its nearby surroundings viewed from above. Hereinafter, the particular area of interest to be used to produce such an image will be referred to simply as the particular area of interest. The extracted image in the particular area of interest is output from the camera image processing unit 24.

For example, to produce an image of the vehicle and its nearby surroundings viewed from above at a parking lot, a particular area is extracted from the image in the imaging area of each of the in-vehicle cameras 9, 10, 11 and 12 so as to include only the ground surface of the parking lot but include no unnecessary objects such as the sky. The other parts, other than the image in the particular area of interest, of the images output from the in-vehicle cameras 9, 10, 11, and 12 are discarded.

The rule of which area should be extracted for particular use from the image taken by each of the in-vehicle camera 9, 10, 11, and 12, that is, the rule of which area of the image taken by each of the in-vehicle camera 9, 10, 11, and 12 should be used may be preset in the ECU 14.

The output end of the camera image processing unit 24 is connected to a calculation unit 25 so that the data of the image in the particular area of interest is extracted from the data output from the in-vehicle cameras 9,10,11, and 12 by the camera image processing unit 24 and is input to the calculation unit 25.

The calculation unit 25 may be connected to a program storage unit 26 in which a program for producing the image showing the vehicle and the nearby surroundings thereof viewed from above the vehicle is stored. The calculation unit 25 executes this program to produce the image of the vehicle and its nearby surroundings viewed from above, using the data of the image of the particular area of interest extracted, by the camera image processing unit 24, from the in-vehicle cameras 9, 10, 11, and 12.

More specifically, the calculation unit 25 produces image data of the surroundings (background) of the vehicle from the data of the image in the particular area of interest extracted from the data output from the in-vehicle cameras 9, 10, 11, and 12, and the calculation unit 25, and produces the image (image data) of the vehicle and its nearby surroundings viewed from above the vehicle by combining the above-described image data and image data representing a plan view of the vehicle.

The output end of the calculation unit 25 may be connected to the display 17 such that the image of the vehicle and its nearby surroundings viewed from above the vehicle, produced by the calculation unit 25, is output to the display 17. Thus, the image of the vehicle and its nearby surroundings viewed from above the vehicle is displayed on the display 17.

In one embodiment, the calculation unit 25 may include a metering area setting unit 28 serving as the metering area setting apparatus which sets the metering area used in the automatic exposure when the in-vehicle cameras 9, 10, 11, and 12 take an image of areas surrounding the vehicle. Furthermore, in one embodiment, a program for setting the metering area is stored in the program storage unit 26. The metering area setting unit 28 sets the metering area by executing this program.

The calculation unit 25 may also be connected to a data storage unit 30 in which information indicating the installation locations on a vehicle of the in-vehicle cameras 9, 10, 11, and 12 (hereinafter, referred to simply as installation location information) is stored.

The calculation unit 25 may also be connected to a vehicle information detector 31 adapted to detect information indicating the current time (hereinafter, referred to simply as time information) and information indicating the direction of the vehicle (hereinafter, referred to simply as vehicle direction information. The detected information is stored in the vehicle. The above information may be acquired, for example, such that the vehicle information detector 31 is connected to an in-vehicle navigation apparatus 5 including a GPS receiver and/or a direction sensor, and the information is acquired from the in-vehicle navigation apparatus 5.

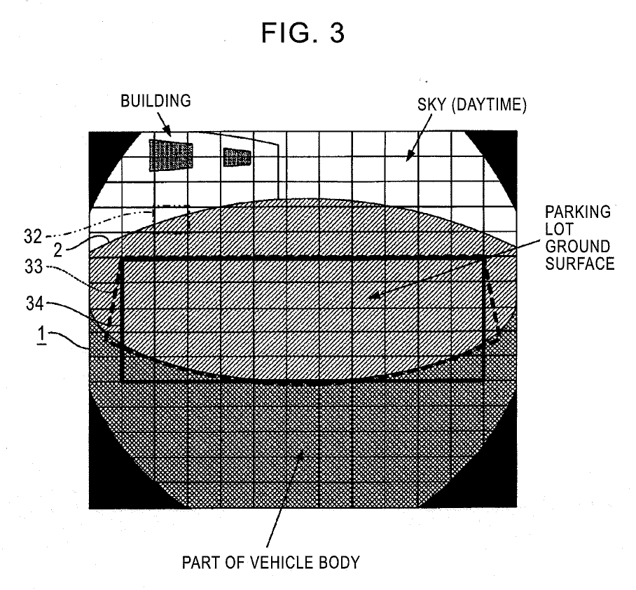

In one embodiment, the metering area setting unit 28 sets the metering area such that an optimum exposure condition is obtained for the particular area of interest of the image. More specifically, as shown in FIG. 3, when the rear camera 10 takes an image of a surrounding scene including a ground surface 2 of a parking lot, the metering area setting unit 28 divides the imaging area 1 of the rear camera 10 into a plurality of blocks 32 which are minimum units in which the metering area is set. The metering area setting unit 28 selects a set of blocks 32 to approximate the particular area 33 of interest in the imaging area 1 of the rear camera 10, and uses the set of selected blocks 32 as the metering area 34. In the example shown in FIG. 3, a set of block 32 in the form of a 5 (vertical)×11 (horizontal) array is selected as the metering area 34. Note that the particular area 33 of interest may be predefined in the metering area setting unit 28. The predefinition in the metering area setting unit 28 may also be given for partial image areas 36, 42, and 43 of the front camera 9, the right-side camera 11, and the left-side camera 12.

The metering area 34 determined in the above-described manner for the rear camera 10 for use in the daytime may not include unnecessary objects such as the sky, and is very similar in shape and size to the particular area 33 of interest of the image. Thus, the resultant metering area 34 allows the exposure condition to be determined to adequately take into account the brightness of the ground surface 2 of the parking lot.

In one embodiment, the metering area setting unit 28 acquires the installation location information stored in the data storage unit 30, and, in accordance with the acquired installation location information, the metering area setting unit 28 sets the metering area adequately such that an exposure condition determined based on the metering area is optimal for the particular area of interest of the image, depending on the installation locations of the respective in-vehicle cameras 9, 10, 11, and 12.

The rear camera 10 may be installed, for example, in a rear license garnish part, or the like, that prevents the rear camera 10 from directly receiving sunlight, while the front camera 9 may be installed, for example, in an emblem part or the like that is difficult to prevent the front camera 9 from directly receiving sunlight.

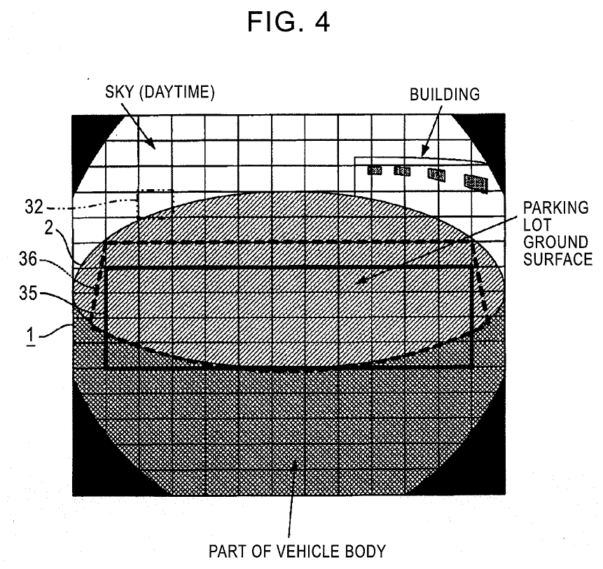

When the front camera 9 takes an image of a surrounding scene including a ground surface 2 of a parking lot in the daytime, the metering area setting unit 28 sets the metering area 35 such that the upper end of the metering area 35 is located at a lower position than the upper end of the metering area 34 for the rear camera 10 shown in FIG. 3. Further, the metering area setting unit 28 sets the metering area 35 such that the metering area 35 is composed of an array of blocks 32 including 4 blocks (in the vertical direction)×11 blocks (in the horizontal direction) as shown in FIG. 4. In this case, the upper end of the metering area 35 is located at a lower position than the upper end of the particular area 36 of interest in the imaging area 1 of the front camera 9.

That is, for use in the daytime, the metering area 35 for the front camera 9 is set depending on the camera installation location such that the upper end of the metering area 35 is lowered to prevent the metering area 35 from being influenced by direct sunlight. Thus, the resultant metering area 35 allows the exposure condition to be determined so as to adequately take into account the brightness of the ground surface 2 of the parking lot.

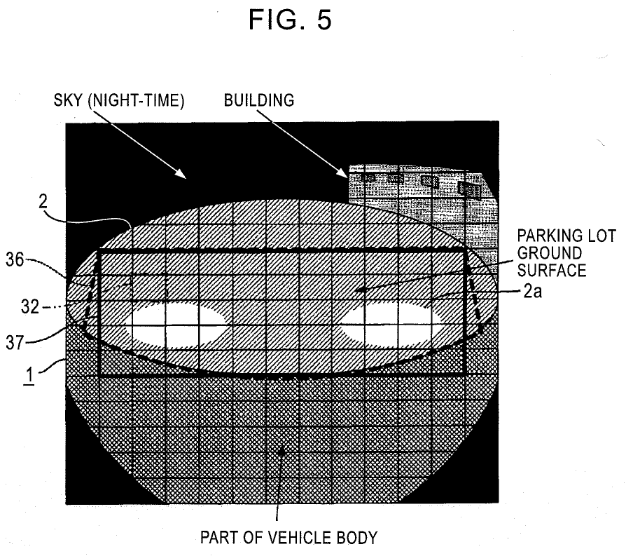

In an alternative embodiment, the metering area setting unit 28 acquires time information detected by the vehicle information detector 31 and sets the metering area depending on the acquired time information such that the exposure condition determined using the metering area depending on the time becomes optimum for the particular area of interest of the image. More specifically, for example, when the front camera 9 takes an image of a surrounding scene including the ground surface 2 of the parking lot in the night-time, it is not necessary to take into account the effects of direct sunlight. Thus, the metering area setting unit 28 sets the metering area 37, as shown in FIG. 5, such that the upper end of the metering area 37 is located at a higher position compared with the daytime metering area 35 for the front camera 9 shown in FIG. 4.

In this case, the metering area 37 is set such that its upper end is located at the same position as the upper end of the particular area 36 of interest in the imaging area 1 of the front camera 9, and such that the metering area 37 best approximates the particular area 36 of interest.

The time-dependent metering area 37 determined in the above-described manner for the front camera 9 may not include unnecessary objects such as the sky, and is very similar in shape and size to the particular area 36 of interest in the imaging area of the front camera 9. Thus, use of this metering area 37 makes it possible to correctly determine the exposure condition for the image in the particular area of interest adequately taking into account the brightness of the ground surface 2 of the parking lot including an area 2a illuminated with light emitted from headlamps.

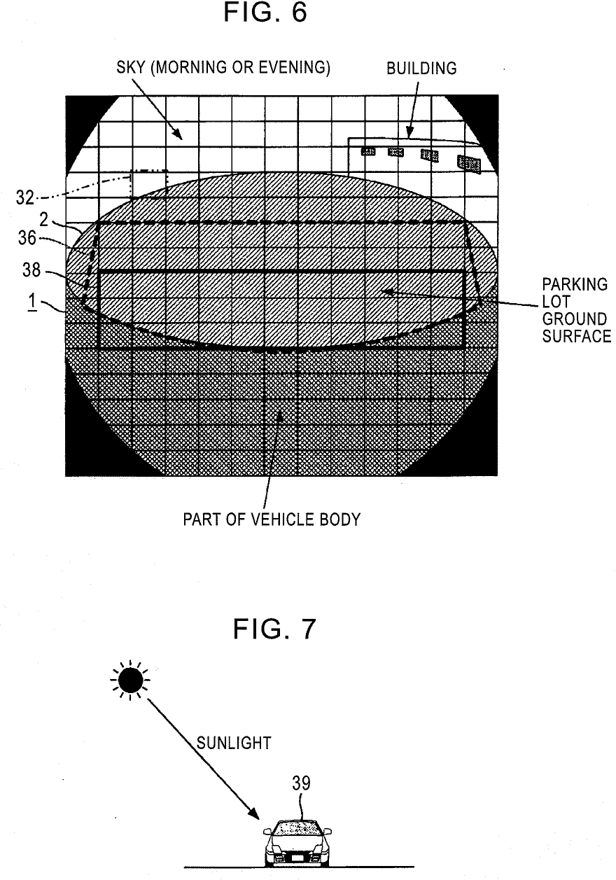

In another example, as described below with reference to FIG. 6, when the front camera 9 takes an image of a surrounding scene including a ground surface 2 of a parking lot at a time in the morning or evening at which sunlight is incident at a small angle on the front part of the vehicle, that is, at a time at which the front camera 9 is likely to receive direct sunlight, the metering area setting unit 28 sets the metering area 38 such that the upper end thereof is located at a further lower position than in the example shown in FIG. 4 to prevent the exposure condition from being improperly influenced by the direct sunlight.

Thus, the setting of the metering area 38 in the above-described manner makes it possible for the exposure condition to be correctly determined taking into account the brightness of the ground surface 2 of the parking lot without being influenced by direct sunlight even at times at which the front camera 9 is likely to receive direct sunlight.

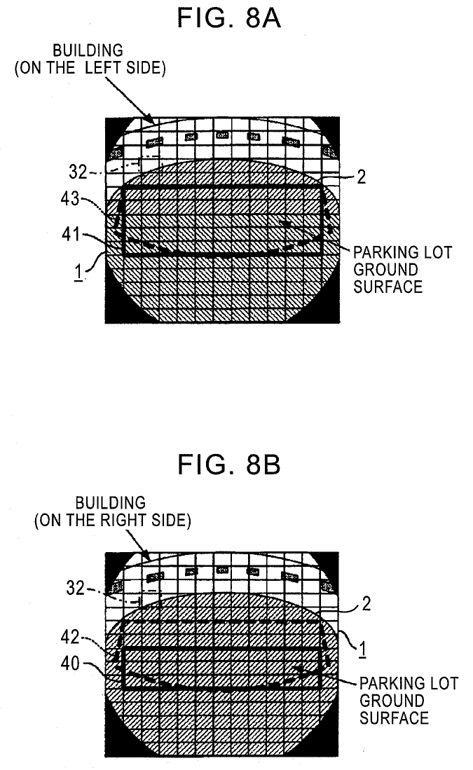

In an alternative embodiment, the metering area setting unit 28 acquires vehicle direction information detected by the vehicle information detector 31 and sets the metering area in accordance with the acquired vehicle direction information such that the determined metering area allows the exposure condition to be correctly determined for the image in the particular area of interest, depending on the vehicle direction. For example, as shown in FIG. 7, when the right-side camera 11 and the left-side camera 12 take an image of a surrounding scene including a ground surface 2 in a parking lot under a condition that the vehicle 39 is in a direction that causes sunlight to strike the right-side door mirror 39a of the vehicle 39, the metering area setting unit 28 sets metering areas 40 and 41 differently for the right side and the left side, as shown in FIG. 8. More specifically, the metering area 40 of the right-side camera 11 is determined such that the upper end thereof is located at a position lower than the upper end of the particular area 42 of interest in the imaging area 1 of the right-side camera 11 so as to prevent the exposure condition from being influenced by direct sunlight.

On the other hand, the metering area 41 for the left-side camera 12 is substantially not influenced by direct sunlight, and thus the metering area 41 is set such that the upper end of the metering area 41 is located at the same position as the upper end of the particular area 43 of interest to be extracted, for use to take the image of the ground surface 2 of the parking lot, from the imaging area 1 of the left-side camera 12 and such that the metering area 41 best approximates the particular area 43 of interest.

Thus, the metering areas 40 and 41 for use in the daytime for the left-side camera 12 and the right-side camera 11 are determined in the above-described manner depending on the direction of the vehicle 39, and the exposure conditions are determined adequately taking into account the brightness of the ground surface 2 of the parking lot.

Referring again to FIG. 2, the calculation unit 25 may be connected to a camera controller 45 so that information associated with the metering area set by the metering area setting unit 28 (hereinafter, referred to simply as metering area information) is input to the camera controller 45. The camera controller 45 outputs a control signal to the in-vehicle cameras 9, 10, 11, and 12 to control them to perform metering in accordance with the input metering area information.

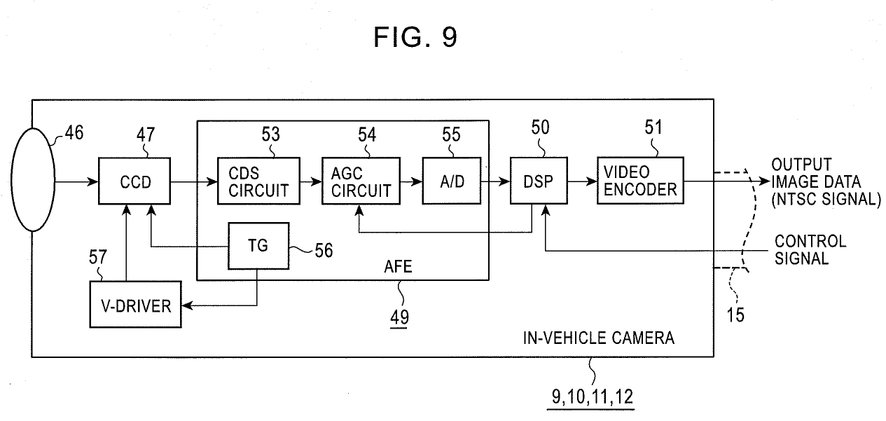

The in-vehicle cameras 9, 10, 11, and 12 are described in further detail below. As shown in FIG. 9, each of the in-vehicle cameras 9, 10, 11, and 12 may have a wide angle lens 46 adapted to focus light incident from the outside.

Each of the in-vehicle cameras 9, 10, 11, and 12 may have a CCD (Charged Coupled Device) 47. The light passing through the wide angle lens 46 is focused on the light sensing surface of the CCD 47. The CCD 47 converts the light incident on the light sensing surface thereof into raw data via a photoelectric conversion, and supplies the resultant raw data to an internal part of each of the in-vehicle cameras 9, 10, 11, and 12.

The output end of the CCD 47 may be connected to an AFE (Analog Front End) 49 such that the raw data output from the CCD 47 is input to the AFE 49. The AFE 49 may include a CDS (Correlated Double Sampling) circuit 53, an AGC (Auto Gain Control) circuit 54 connected to the output end of the CDS circuit 53, an analog-to-digital converter 55 connected to the output end of the AGC circuit 54, and a TG (Timing Generator) 56. The CDS circuit 53 removes noise from the raw data input from the CCD 47 and outputs the resultant raw data to the AGC circuit 54.

The AGC circuit 54 controls the input gain of the raw data at a value corresponding to the determined exposure condition, and supplies the resultant data to the analog-to-digital converter 55, which converts the supplied raw data into a digital form, thereby automatically controlling the exposure of the in-vehicle cameras 9, 10, 11, and 12. Under the control of the AGC circuit 54 in terms of the input gain, the analog-to-digital converter 55 converts the raw data into digital data and outputs the resultant digital data to the outside of the AFE 49.

The TG 56 controls a horizontal scanning operation of the CCD 47.

The AFE 49 may be connected to a DSP (Digital Signal Processor) 50 such that the digital data converted from the raw data by the analog-to-digital converter 55 is input to the DSP 50. The DSP 50 converts the given raw data into a YUV signal by performing signal-processing including a correction (gamma-correction) process on the given raw data, and the DSP 50 outputs the resultant YUV signal. The camera controller 45 outputs a control signal to the DSP 50. The DSP 50 determines the exposure condition by performing metering based on the metering area according to the received control signal. Information associated with the determined exposure condition (hereinafter referred to as exposure information) is supplied to the AGC circuit 54 of the AFE 49.

Because the exposure condition is determined by the DSP 50 on the basis of the metering area set by the metering area setting unit 28, the determined exposure condition is optimal for the particular area of interest of the image. More specifically, in the case in which an image of the ground surface 2 of the parking lot shown in one of FIGS. 3 to 6 or FIG. 8 is taken, the DSP 50 determines the exposure condition adequately taking into account the brightness of the ground surface 2 of the parking lot.

The output end of the DSP 50 may be connected to a video encoder 51 such that the YUV signal output from the DSP 50 is input to the video encoder 51. The video encoder 51 converts the input YUV signal in digital form into an analog signal according to the NTSC (National Television Standards Committee) standard. The resultant NTSC signal is output, as image data taken by the in-vehicle camera 9, 10, 11, or 12, to the ECU 14.

In the present embodiment, there is provided a V-driver 57 between the TG 56 and the CCD 47 in the AFE 49. The V-driver 57 converts the voltage level of the voltage output from the TG 56 to a proper level and controls vertical scanning of the CCD 47 using the converted voltage.

The operation of the in-vehicle camera system 8 using the automatic exposure method according to the first embodiment of the present invention is described below. In the present embodiment, first, a user operates an input device such as a touch panel on the display 17 or a remote control (not shown) to input a command to the ECU 14 to display an image of the vehicle and the nearby surroundings thereof viewed from above the vehicle. In response to the input operation, the metering area setting unit 28 sets the metering area in accordance with at least one of the installation locations of the in-vehicle cameras 9, 10, 11, and 12, the time, and the vehicle direction such that an exposure condition is determined optimally for the particular area of interest of the image, such as that shown in one of FIGS. 3 to 6 or FIG. 8. The metering area setting unit 28 outputs metering area information indicating the determined metering area to the camera controller 45.

The camera controller 45 outputs a control signal to the DSP 50 of each of the in-vehicle cameras 9, 10, 11, and 12 to perform metering in accordance with the metering area information output from the metering area setting unit 28. The DSP 50 determines the exposure condition by performing metering using the metering area in accordance with the control signal output from the camera controller 45, and outputs the exposure information indicating the determined exposure condition to the AGC circuit 54 of the AFE 49. In accordance with the exposure information output from the DSP 50, the AGC circuit 54 controls the input gain for the analog-to-digital conversion of the raw data output from the CCD 47.

Thus, automatic exposure is performed in accordance with at least one of the installation locations of the in-vehicle cameras 9, 10, 11, and 12, the time, and the vehicle direction. For example, when an image of a surrounding scene including the ground surface 2 of the parking lot is taken in the daytime by the in-vehicle cameras 9, 10, 11, and 12, the metering area 34 of the rear camera 10 is set as shown in FIG. 3 and the metering area 35 of the front camera 9 is set as shown in FIG. 4. In this state, the exposure condition is determined based on the determined metering area 35 and automatic exposure is performed under the determined condition. Thus, the exposure condition is determined adequately taking into account the brightness of the ground surface 2 of the parking lot without being influenced by the brightness of the undesirable object such as the sky. That is, the automatic exposure is performed under the condition optimum for the particular area of interest (that is, underexposure does not occur). In this case, the metering areas for the right-side camera 11 and that for the left-side camera 12 are selected, as in the example shown in FIG. 3, such that an area equal to or approximately equal to the particular area of interest in the imaging area 1 of each of the in-vehicle cameras 11 and 12 is used as the metering area. When the vehicle is in a particular direction, as in the example shown in FIG. 8, the metering areas 40 and 41 may be selected differently for the right-side camera 11 and the left-side camera 12.

For example, when an image of a surrounding scene including a ground surface 2 of a parking lot is taken in the nighttime by the in-vehicle cameras 9, 10, 11, and 12, because the metering area 37 for the front camera 9 is set as shown in FIG. 5, the automatic exposure of the front camera 9 is performed under an adequate condition in which the brightness of the ground surface 2 of the parking lot is correctly taken into account (that is, under an exposure condition optimum for the particular area of interest to be used), and thus overexposure does not occur for the areas 2a illuminated by light emitted from the headlamps. In this case, the metering areas for the rear camera 10, the right-side camera 11, and that for the left-side camera 12 are set such that an area equal to or approximately equal to the particular area of interest in the imaging area 1 of each of the in-vehicle cameras 10, 11, and 12 is used as the metering area.

The raw data taken in the above-described manner and converted from analog form into digital form by the analog-to-digital converter 55 is output to the DSP 50. The DSP 50 converts the raw data supplied from the analog-to-digital converter 55 into a YUV signal and outputs the resultant YUV signal to the video encoder 51. The video encoder 51 converts the raw data output from the DSP 50 into a NTSC signal and outputs the resultant NTSC signal, as image data taken by the respective in-vehicle cameras 9, 10, 11, and 12, to the ECU 14.

If the ECU 14 receives the image data taken and output by the respective in-vehicle cameras 9, 10, 11, and 12, the respective image data is input to the camera image input units 19, 20, 21, and 22 corresponding to the in-vehicle cameras 9, 10, 11, and 12. Each of the camera image input units 19, 20, 21, and 22 converts the input image data from analog form into digital form and outputs the resultant digital image data to the camera image processing unit 24.

The camera image processing unit 24 extracts an image in the particular area of interest (for example, an image of the ground surface 2 of the parking lot) from the image data output from each of the camera image input units 19, 20, 21, and 22, and the camera image processing unit 24 supplies the extracted data of the image of the particular area of interest to the calculation unit 25. The calculation unit 25 produces an image of the vehicle and the surroundings thereof viewed from above by using the data of the images in the particular areas of interest output from the camera image processing unit 24. The produced image is displayed on the display 17.

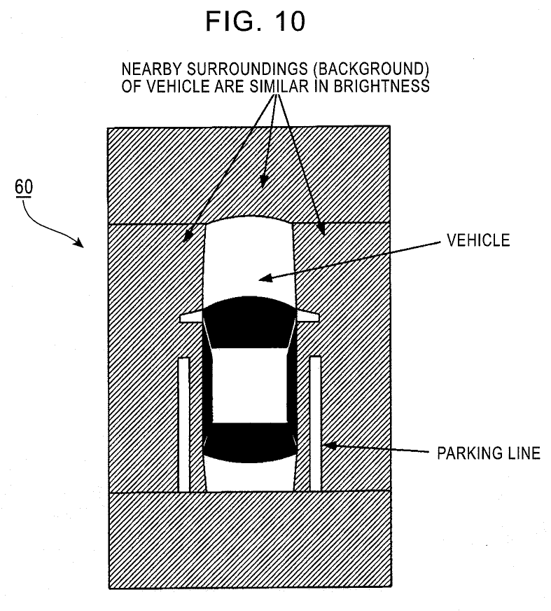

Because the image in each particular area of interest is taken under the optimum exposure condition, it is possible to produce a good image 60 of the vehicle and the surrounding scene viewed from above, in which there is no significant difference in brightness among the area in front of the vehicle, the area behind the vehicle, the area to the left of the vehicle, and the area to the right of the vehicle, as shown in FIG. 10.

### Second Embodiment

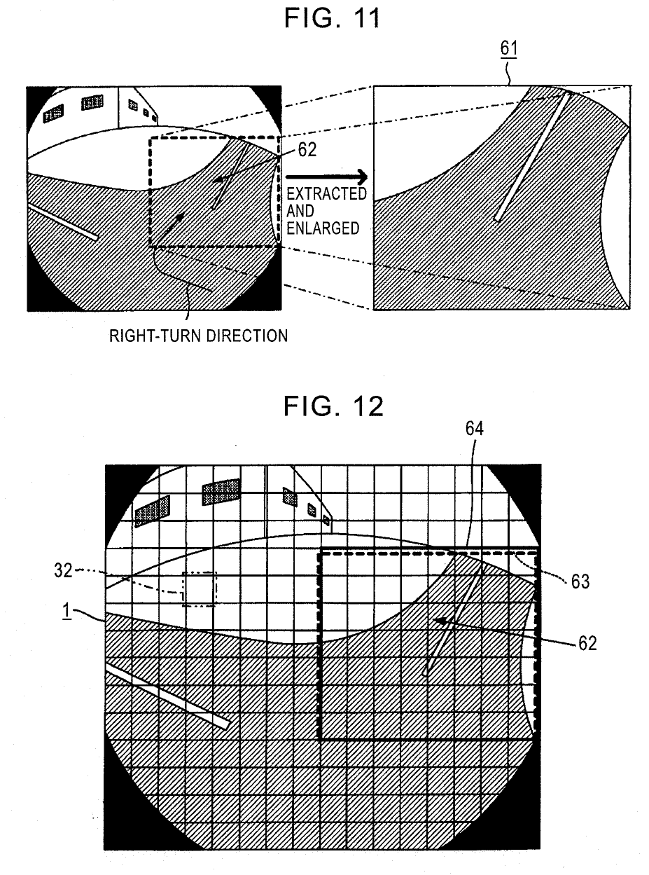

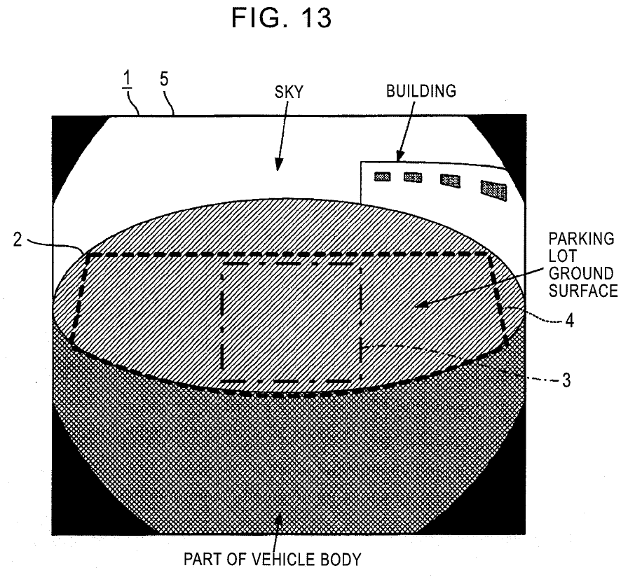

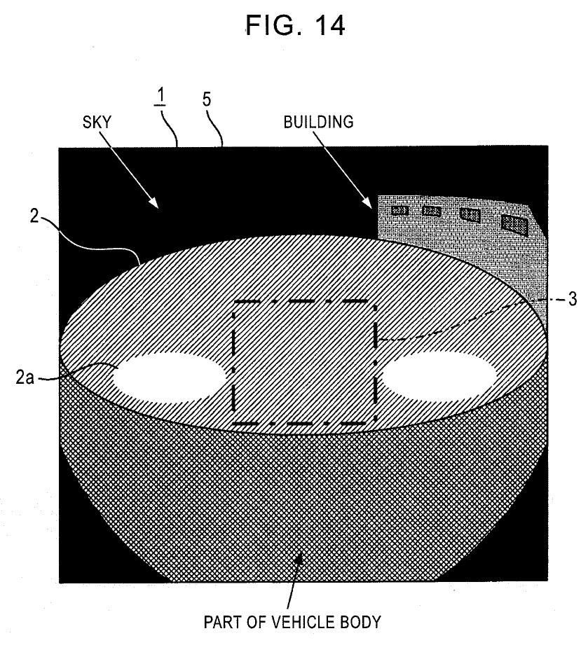

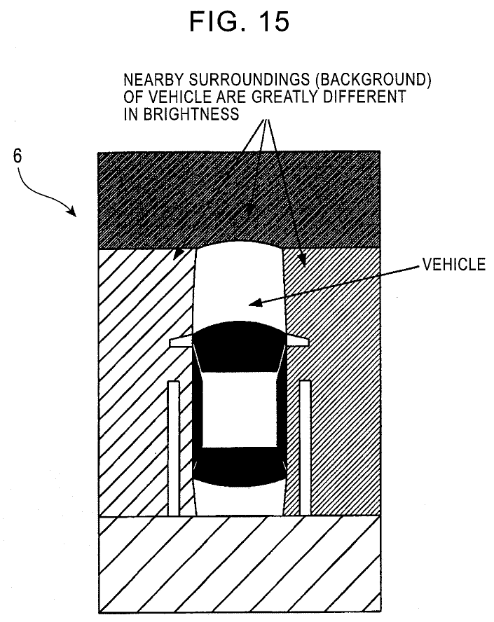

An in-vehicle camera automatic-exposure apparatus and an in-vehicle automatic-exposure method according to a second embodiment of the present invention are described below with reference to FIGS. 11 and 12. In the following description, similar parts to those in the first embodiment will be denoted by similar reference numerals.

An in-vehicle camera automatic-exposure apparatus includes in-vehicle cameras 11 and 12 and an ECU 14. As in the first embodiment described above, the ECU 14 is connected to a display 17 to form an in-vehicle camera system 8. However, unlike the first embodiment, a right-side camera 11 or a left-side camera 12 takes an image of a vehicle and a surrounding scene including a road surface and extracts a particular area of the image taken by the right-side camera 11 or 12 to therefrom produce an image for checking whether there is an obstacle (hereinafter, referred to simply as an obstacle checking image), which is displayed on the display 17. To achieve the above object, the in-vehicle automatic-exposure apparatus may include only the right-side camera 11 and the left-side camera 12 as the in-vehicle cameras. However, to configure the in-vehicle automatic-exposure apparatus to also have the capability of displaying the image of the vehicle and the surrounding scene viewed from above as in the first embodiment, the in-vehicle automatic-exposure apparatus may include additional in-vehicle cameras 9 and 10.

In a specific configuration according to the present embodiment, the camera image processing unit 24 extracts a particular area of interest selected for use in producing an image for checking whether there is an obstacle (hereinafter, referred to simply as a particular area of interest) from the data of the image taken by the right-side camera 11 or the left-side camera 12, and the camera image processing unit 24 outputs the extracted image data to the calculation unit 25.

The rule of selecting a particular area of interest for the above-described purpose from the imaging area of the in-vehicle camera 11 or 12, that is, the extraction rule may be preset in the ECU 14 for each of the in-vehicle camera 11 or 12.

The calculation unit 25 produces the obstacle checking image by enlarging the image in the particular area of interest output from the camera image processing unit 24. The produced obstacle checking image is displayed on the display 17.

For example, when the right-side camera 11 takes an image of a surrounding scene including the surface 62 of a road on the right side of the vehicle going to turn to the right, as shown on the left side of FIG. 11, an area enclosed by a broken line in the total image shown in FIG. 11 is extracted for the above-described purpose. The extracted image is then enlarged to produce the image 61 for checking whether there is no obstacle in the way of right-turning to the road.

A program for producing the obstacle checking image is stored in the program storage unit 26, and the calculation unit 25 produces the obstacle checking image by executing this program.

The vehicle information detector 31 detects the running conditions of the vehicle, such as a running direction of the vehicle, a rudder angle of a steering wheel, etc. (hereinafter, the information indicating such running conditions will be referred to as running condition information). In the present embodiment, on the basis of the running condition information detected by the vehicle information detector 31, the calculation unit 25 determines which one of the cameras (the right-side camera 11 or the left-side camera 12) should be used to produce the obstacle checking image. For example, if the running condition information indicates that the vehicle is going to turn to the right, then the calculation unit 25 determines that the right-side camera 11 should be used to produce the image for checking that there is no obstacle in the turn-to-right way.

In the present embodiment, the metering area setting unit 28 sets the metering area such that an optimum exposure condition is obtained for a particular area of interest in the imaging area for the right-side camera 11 or the left-size camera 12 which has been determined to be used to produce the obstacle checking image. For example, when the vehicle is going to turn to the right, it is determined that the right-side camera 11 should be used to produce an image of a surrounding scene including a road surface 62 of a road to which the vehicle is going to turn. In this case, as shown in FIG. 12, the metering area setting unit 28 divides the imaging area 1 of the right-side camera 11 into a plurality of blocks 32 used as minimum units in which to set the metering area.

The metering area setting unit 28 selects a set of blocks 32 so as to best approximate the particular area 63 of interest in the imaging area 1 of the right-side camera 11, thereby setting the metering area 64. Note that the particular area 63 to be used may be preset in the metering area setting unit 28.

The metering area 64 set in the above-described manner for the right-side camera 11 allows it to determine an exposure condition adequately taking into account the brightness of the road surface 62 of the road to which the vehicle is going to turn.

Information indicating the metering area set by the metering area setting unit 28 (hereinafter, referred to simply as metering area information) is output to the camera controller 45. The camera controller 45 outputs a control signal to the DSP 50 of the selected in-vehicle camera (the right-side camera 11 or the left-side camera 12) to perform metering in accordance with the metering area information.

The DSP 50 performs metering using the metering area in accordance with the control signal supplied from the camera controller 45 and determines the exposure condition. The DSP 50 then outputs information indicating the determined exposure condition (hereinafter referred to simply as exposure information) to the AGC circuit 54 of the AFE 49.

The AGC circuit 54 controls the input gain, used in the analog-to-digital conversion of the raw data, to a value corresponding to the exposure information thereby performing automatic exposure of the selected in-vehicle camera (the right-side camera 11 or the left-side camera 12).

The operation of the in-vehicle camera system 8 using the automatic exposure method according to the second embodiment of the present invention is described below. If a user (a driver) of a vehicle performs a driving operation to turn to the right or left at an intersection or the like, the vehicle information detector 31 detects the driving operation as driving condition information and outputs the driving condition information to the calculation unit 25.

In accordance with the driving condition information received from the vehicle information detector 31, the calculation unit 25 determines which in-vehicle camera (the right-side camera 11 or the left-side camera 12) should be used to produce the obstacle checking image.

The metering area setting unit 28 determines the metering area for the in-vehicle camera 11 or 12 selected by the calculation unit 25 such that the metering area allows the exposure condition to be determined so as to be optimal for the particular area of interest to be used to produce the obstacle checking image as shown in FIG. 12.

The calculation unit 25 outputs metering area information indicating the metering area set by the metering area setting unit 28 to the camera controller 45. The camera controller 45 outputs the control signal to the DSP 50 of the selected in-vehicle camera (the right-side camera 11 or the left-side camera 12) to perform metering in accordance with the metering area information output by the calculation unit 25.

The DSP 50 performs metering using the metering area in accordance with the control signal supplied from the camera controller 45 and determines the exposure condition according to the metering result. The exposure information indicating the determined exposure condition is supplied to the AGC circuit 54 of the AFE 49.

In accordance with the exposure information received from the DSP 50, the AGC circuit 54 controls the input gain used in the analog-to-digital conversion of the raw data input from the CCD 47. The image is taken under the determined exposure condition, and thus optimum exposure is achieved for the particular area of interest to be used to produce the obstacle checking image.

The raw data is converted from analog form into digital form by the analog-to-digital converter 55 and is output to the DSP 50. The DSP 50 converts the raw data supplied from the analog-to-digital converter 55 into a YUV signal and outputs the resultant YUV signal to video encoder 51. The video encoder 51 converts the raw data received from the DSP 50 into a NTSC signal and outputs the resultant NTSC signal, as the image data of the in-vehicle camera 11 or 12, to the ECU 14.

The image data supplied to the ECU 14 from the in-vehicle camera 11 or 12 is input to the camera image input unit 21 or 22 corresponding to the selected in-vehicle camera 11 or 12. The camera image input unit 21 or 22 converts the input image data from analog form into digital form and outputs the resultant digital image data to the camera image processing unit 24.

The camera image processing unit 24 extracts the particular area of interest from the image data output from the camera image input unit 21 or 22 and outputs the extracted image data of the particular area of interest to the calculation unit 25. The calculation unit 25 produces the obstacle checking image by enlarging the image of the particular area of interest output from the camera image processing unit 24. The produced obstacle checking image is displayed on the display 17. Because the exposure has been performed so as to achieve the optimum exposure condition for the particular area of interest, the displayed obstacle checking image has adequate brightness.

As described above, the in-vehicle camera automatic-exposure method/apparatus according to the present invention allows the metering area to be adequately set so as to achieve an optimum exposure condition for a particular area of interest in the imaging area of each of the in-vehicle cameras 9, 10, 11, and 12. Thus it is possible to obtain optimum brightness for an image produced from the image of the particular area of interest.

The present invention has been described above with reference to specific embodiments. However, the present invention is not limited to these embodiments, but various modifications are possible without departing from the spirit and the scope of the invention. It is therefore intended that the foregoing detailed description be regarded as illustrative rather than limiting, and that it be understood that it is the following claims, including all equivalents, that are intended to define the spirit and scope of this invention.

What is claimed is:

1. An in-vehicle camera automatic-exposure apparatus, comprising:
a metering area setting apparatus configured to set a metering area for use in automatic exposure in an in-vehicle camera taking an image of a scene including at least one of a ground surface of a parking space, an area surrounding a vehicle, and a road surface, wherein the metering area is set such that an exposure condition determined based on the metering area is optimal for a particular area of interest of the image taken by the in-vehicle camera,
wherein the automatic exposure is performed using the metering area set by the metering area setting apparatus.

2. The in-vehicle camera automatic-exposure apparatus according to claim 1, wherein the image in the particular area of interest is an image used to produce an image of the vehicle and its surroundings viewed from above the vehicle, and wherein the metering area setting apparatus is configured to set the metering area based on a location on the vehicle of the in-vehicle camera.

3. The in-vehicle camera automatic-exposure apparatus according to claim 1, wherein the image in the particular area of interest is an image used to produce an image of the vehicle and its surroundings viewed from above the vehicle, and wherein the metering area setting apparatus is configured to set the metering area based on time.

4. The in-vehicle camera automatic-exposure apparatus according to claim 1, wherein the image in the particular area of interest is an image used to produce an image of the vehicle and its surroundings viewed from above the vehicle, and wherein the metering area setting apparatus is configured to set the metering area based on a direction that the vehicle is facing.

5. The in-vehicle camera automatic-exposure apparatus according to claim 1, wherein the image in the particular area of interest is an image used to produce an image of the vehicle and its surroundings viewed from above the vehicle, and wherein the metering area setting apparatus is configured to set the metering area based on at least one of a location on the vehicle of the in-vehicle camera, time, and a direction that the vehicle is facing.

6. The in-vehicle camera automatic-exposure apparatus according to claim 1, wherein the image in the particular area of interest is an image used to produce an image of the vehicle and its surroundings viewed from above the vehicle, and wherein the metering area setting apparatus is configured to set the metering area to include an area equal or approximately equal to the particular area of interest of the image to be used.

7. The in-vehicle camera automatic-exposure apparatus according to claim 1, wherein the image of the particular area of interest is an image to be extracted from the image of the scene taken by the in-vehicle camera, and wherein the metering area setting apparatus is configured to set the metering area to include an area equal or approximately equal to the particular area of interest of the image to be used.

8. The in-vehicle camera automatic-exposure apparatus according to claim 7, wherein the image in the particular area of interest is an image to be extracted from the image of the scene taken by the in-vehicle camera, which is used to produce an image for identifying obstacles near the vehicle.

9. The in-vehicle camera automatic-exposure apparatus according to claim 8, wherein the in-vehicle camera is a wide angle camera.

10. An in-vehicle automatic-exposure method, comprising the steps of:
setting a metering area for use in automatic exposure in an in-vehicle camera taking an image of a scene including at least one of a ground surface of a parking space and a road surface, the metering area set such that an exposure condition determined based on the metering area becomes optimal for a particular area of interest of the image taken by the in-vehicle camera, wherein the in-vehicle camera is located on a vehicle; and
performing the automatic exposure using the set metering area.

11. The in-vehicle automatic-exposure method according to claim 10, wherein the image in the particular area of interest is an image to be used to produce an image of the vehicle and its surroundings viewed from above the vehicle, and wherein the metering area is set based on where the in-vehicle camera is installed on the vehicle.

12. The in-vehicle automatic-exposure method according to claim 10, wherein the image in the particular area of interest is an image used to produce an image of the vehicle and its surroundings viewed from above the vehicle, and wherein the metering area is set based on time.

13. The in-vehicle automatic-exposure method according to claim 10, wherein the image in the particular area of interest is an image used to produce an image of the vehicle and its surroundings viewed from above the vehicle, and wherein the metering area is set based on a direction that the vehicle is facing.

14. The in-vehicle automatic-exposure method according to claim 10, wherein the image in the particular area of interest is an image used to produce an image of the vehicle and its surroundings viewed from above the vehicle, and wherein the metering area is set based on at least one of where the in-vehicle camera is installed on the vehicle, time, and a direction that the vehicle is facing.

15. The in-vehicle automatic-exposure method according to claim 10, wherein the image in the particular area of interest is an image used to produce an image of the vehicle and its surroundings viewed from above the vehicle, and wherein the metering area is set to include an area equal or approximately equal to the particular area of interest of the image to be used.

16. The in-vehicle automatic-exposure method according to claim 10, wherein the image of the particular area of interest is an image to be extracted from the image of the surrounding scene taken by the in-vehicle camera, and wherein the metering area is set to include an area equal or approximately equal to the particular area of interest of the image to be used.

17. The in-vehicle automatic-exposure method according to claim 16, wherein the image in the particular area of interest is an image which is extracted from the image of the scene taken by the in-vehicle camera, which is used to produce an image for identifying obstacles near the vehicle.

18. The in-vehicle automatic-exposure method according to claim 17, wherein a wide angle camera is used as the in-vehicle camera.
